(19) United States
(12) Patent Application Publication
(10) Pub. No.: US 2024/0217545 A1
(43) Pub. Date: Jul. 4, 2024

(54) VEHICLE CONTROLLER, METHOD, AND COMPUTER PROGRAM FOR VEHICLE CONTROL

(71) Applicant: TOYOTA JIDOSHA KABUSHIKI KAISHA, Toyota-shi Aichi-ken (JP)

(72) Inventor: Kenta Kumazaki, Tokyo-to (JP)

(73) Assignee: TOYOTA JIDOSHA KABUSHIKI KAISHA, Toyota-shi Aichi-ken (JP)

(21) Appl. No.: 18/382,756

(22) Filed: Oct. 23, 2023

(30) Foreign Application Priority Data
Dec. 28, 2022 (JP) 2022-211402

(51) Int. Cl. B60W 60/00; G01C 21/00

(52) U.S. Cl. CPC B60W 60/001; G01C 21/387; B60W 2556/40

(57) ABSTRACT

A vehicle controller includes a processor configured to detect, in a travel direction of a vehicle, an inconsistent section where information on a road represented in a first map is inconsistent with information on the road represented in a second map, the road being traveled by the vehicle, and the first and second maps being updated at different timings, generate a planned trajectory regarding a section from the current position of the vehicle to a predetermined distance away in the travel direction of the vehicle except the inconsistent section, based on the first map, generate the planned trajectory regarding the inconsistent section, based on a map, of the first and second maps, with a shorter elapsed time since the timing of the last update of information on the road in the inconsistent section, and control the vehicle so that the vehicle travels along the generated planned trajectory.

### CROSS-REFERENCE TO RELATED APPLICATION

This application claims priority to Japanese Patent Application No. 2022-211402 filed on Dec. 28, 2022, the entire contents of which are herein incorporated by reference.

### FIELD

The present disclosure relates to a vehicle controller, a method, and a computer program for vehicle control.

### BACKGROUND

A technique to execute autonomous driving control of a vehicle or driving assistance for a vehicle driver by referring to map information has been researched. However, a vehicle may enter an area that is not covered by map information during travel of the vehicle, which results in the map information becoming unavailable. In view of this, a technique to switch from a travel path based on map information to another travel path has been proposed (see International Publication WO2019/026210A).

A travel assistance device disclosed in WO2019/026210A generates a first travel path, based on map information around a host vehicle, and generates a second travel path, based on detected surrounding environment. When detecting that the first travel path will not be generated ahead of the host vehicle during travel of the host vehicle along the first travel path, the travel assistance device determines that a switch from the first travel path to the second travel path is necessary. When it is determined that the switch is necessary, the travel assistance device controls the host vehicle to switch from the first travel path to the second travel path.

### SUMMARY

In some cases, map information used for generating a trajectory to be traveled by a vehicle (hereafter simply a “planned trajectory”) does not represent the latest road conditions. For example, construction in a road section represented in map information after generation or update of the map information may cause inconsistency between information on the road section represented in the map information and actual information on the road section. In such a case, a planned trajectory generated on the basis of the map information may not lie along a lane in the road section, which may result in a vehicle swaying or almost deviating from the lane when the vehicle is made to travel along the planned trajectory.

It is an object of the present disclosure to provide a vehicle controller that can prevent erroneously generating a planned trajectory such that the vehicle deviates from a lane being traveled.

According to an embodiment, a vehicle controller is provided. The vehicle controller includes a memory configured to store a first map and a second map each representing information on a road; and a processor configured to: detect, in a travel direction of a vehicle, an inconsistent section where information on a road represented in the first map is inconsistent with information on the road represented in the second map, the road being traveled by the vehicle, and the first and second maps being updated at different timings, generate a planned trajectory to be traveled by the vehicle regarding a section from a current position of the vehicle to a predetermined distance away in the travel direction of the vehicle except the inconsistent section, based on the first map, generate the planned trajectory regarding the inconsistent section, based on a map, of the first and second maps, with a shorter elapsed time since the timing of the last update of information on the road in the inconsistent section, and control the vehicle so that the vehicle travels along the generated planned trajectory.

In some embodiments, the vehicle controller, the information on the road represented in the first map is more accurate than the information on the road represented in the second map, and the second map is updated more frequently than the first map.

In some embodiments, the processor of the vehicle controller is further configured to connect the planned trajectory generated regarding the inconsistent section and the planned trajectories generated regarding sections in front of and behind the inconsistent section with predetermined curves.

In some embodiments, the processor of the vehicle controller generates the planned trajectory from a point that is a predetermined offset distance closer to the current position of the vehicle than a start point of the inconsistent section closest to the current position of the vehicle in the inconsistent section, based on the map, of the first and second maps, with a shorter elapsed time since the timing of the last update of information on the road in the inconsistent section.

In some embodiments, when two inconsistent sections separated by a distance less than a predetermined distance threshold are detected, the processor of the vehicle controller determines a continuous section including the two inconsistent sections as a single inconsistent section.

According to another embodiment, a method for vehicle control is provided. The method includes detecting an inconsistent section where information represented in a first map is inconsistent with information represented in a second map regarding a predetermined road section that is a predetermined distance away from a current position of a vehicle in a travel direction of the vehicle, the first and second maps being updated at different timings; generating a planned trajectory to be traveled by the vehicle regarding the section from the current position of the vehicle to the predetermined distance away in the travel direction of the vehicle except the inconsistent section, based on the first map; generating the planned trajectory regarding the inconsistent section, based on a map, of the first and second maps, with a shorter elapsed time since the timing of the last update of information on the road being traveled by the vehicle in the inconsistent section; and controlling the vehicle so that the vehicle travels along the generated planned trajectory.

According to still another embodiment, a non-transitory recording medium that stores a computer program for vehicle control is provided. The computer program includes instructions causing a processor mounted on a vehicle to execute a process including detecting an inconsistent section where information represented in a first map is inconsistent with information represented in a second map regarding a predetermined road section that is a predetermined distance away from a current position of the vehicle in a travel direction of the vehicle, the first and second maps being updated at different timings; generating a planned trajectory to be traveled by the vehicle regarding the section from the current position of the vehicle to the predetermined distance away in the travel direction of the vehicle except the inconsistent section, based on the first map; generating the planned trajectory regarding the inconsistent section, based on a map, of the first and second maps, with a shorter elapsed time since the timing of the last update of information on the road being traveled by the vehicle in the inconsistent section; and controlling the vehicle so that the vehicle travels along the generated planned trajectory.

The vehicle controller according to the present disclosure has an effect of being able to prevent erroneously generating a planned trajectory such that the vehicle deviates from a lane being traveled.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process.

FIG. 4A schematically illustrates an example of the relationship between the degree of inconsistency of two maps and an inconsistent section.

FIG. 4B schematically illustrates another example of the relationship between the degree of inconsistency of two maps and an inconsistent section.

FIG. 5 schematically illustrates an example of detection of an inconsistent section according to a modified example.

FIG. 6 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller generates a planned trajectory, using one of two maps updated at different timings, and makes a vehicle travel along the generated planned trajectory. More specifically, the vehicle controller detects an inconsistent section where two pieces of information on a road being traveled by the vehicle represented in the two maps are inconsistent with each other, in a section from the current position of the vehicle to a predetermined distance away in the travel direction of the vehicle. Regarding a road section except the inconsistent section, the vehicle controller generates a planned trajectory, based on a normally used one of the two maps. Regarding the inconsistent section, the vehicle controller generates a planned trajectory, based on a map, of the two maps, with a shorter elapsed time since the timing of the last update of information on the road in the inconsistent section.

In the present embodiment, the two maps each include information used for generating a planned trajectory, e.g., information indicating the types of features, such as road markings including lane-dividing lines, curbstones, signposts, and roadside signboards, and information indicating the positions of these features, as information on a road.

In some embodiments, of the two maps, a map representing more accurate information on a road is set as the normally used map (hereafter the “first map”). This increases the possibility of generation of a planned trajectory that appropriately lies along a lane being traveled by the vehicle. It is assumed that information on a road represented in a map is more accurate as the error in the position of a feature on or around the road represented in the map is smaller or the type and the presence or absence of the feature are more reliable. In some embodiments, thus the accuracy of the position of a feature and the reliability of the type and the presence or absence of the feature in a road section unchanged after the last update of the first map and the other map (hereafter the “second map”) are higher in the first map than in the second map. However, the accuracy of information on the road may be the same between the two maps. In the present embodiment, the timing of update of a map refers to that of update of information on a road represented in the map. For example, in the case where a map server that manages a map or delivers a map to vehicles updates information on a predetermined road section of the first map at a first date and time, the first date and time is the timing of update.

In some embodiments, the second map is updated more frequently than the first map. This may result in, for example, the timing of the last update of the second map being later than construction in a predetermined road section, even if the first map does not represent correct information on the predetermined road section because the construction in the predetermined road section has been done after the last update of the first map. For this reason, the second map may represent correct information on the predetermined road section. Thus by selectively using the first and second maps depending on the situation, the vehicle controller can generate an appropriate planned trajectory such that the vehicle can continue traveling without deviating from a lane being traveled.

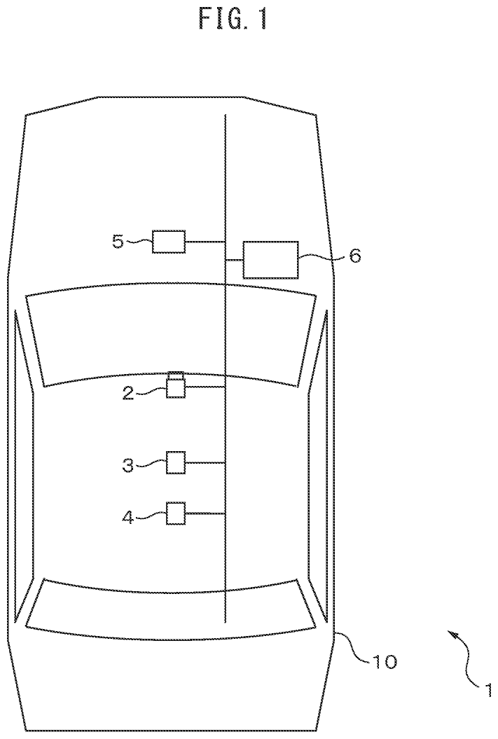

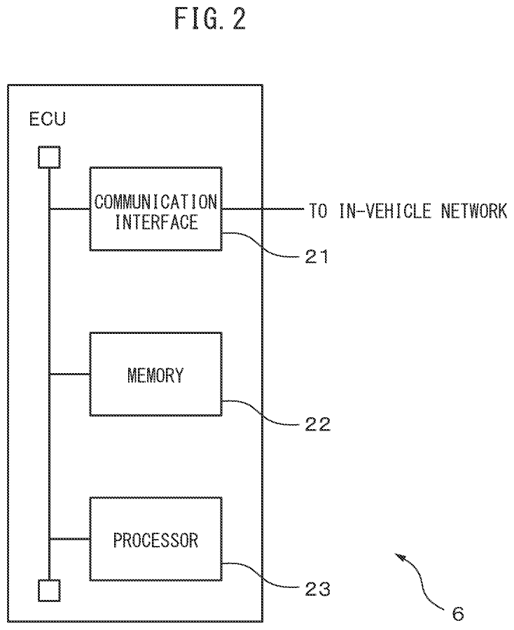

FIG. 1 schematically illustrates the configuration of a vehicle control system equipped with a vehicle controller. FIG. 2 illustrates the hardware configuration of an electronic control unit, which is an embodiment of the vehicle controller. In the present embodiment, the vehicle control system 1, which is mounted on a vehicle 10 and controls the vehicle 10, includes a camera 2, a GPS receiver 3, a wireless communication terminal 4, a storage device 5, and an electronic control unit (ECU) 6, which is an example of the vehicle controller. The camera 2, the GPS receiver 3, the wireless communication terminal 4, and the storage device 5 are communicably connected to the ECU 6 via an in-vehicle network conforming to a standard such as a controller area network. The vehicle control system 1 may further include a range sensor (not illustrated) that measures the distances from the vehicle 10 to objects around the vehicle 10, such as LiDAR or radar. The vehicle control system 1 may further include a navigation device (not illustrated) for searching for a route to a destination.

The camera 2, which is an example of a sensor that generates a sensor signal representing the surroundings of the vehicle 10, includes a two-dimensional detector constructed from an array of optoelectronic transducers, such as CCD or C-MOS, having sensitivity to visible light and a focusing optical system that forms an image of a target region on the two-dimensional detector. The camera 2 is mounted, for example, in the interior of the vehicle 10 so as to be oriented, for example, to the front of the vehicle 10. The camera 2 takes a picture of a region in front of the vehicle 10 every predetermined capturing period (e.g., 1/30 to 1/10 seconds), and generates images representing this region. Each image obtained by the camera 2 is an example of the sensor signal. The vehicle 10 may include multiple cameras taking pictures in different orientations or having different focal lengths.

Every time an image is generated, the camera 2 outputs the generated image to the ECU 6 via the in-vehicle network.

The GPS receiver 3 receives GPS signals from GPS satellites at predetermined intervals, and determines the position of the vehicle 10, based on the received GPS signals. The GPS receiver 3 outputs positioning information indicating the result of determination of the position of the vehicle 10 based on the GPS signals to the ECU 6 via the in-vehicle network at predetermined intervals. Instead of the GPS receiver, the vehicle 10 may include a receiver that receives positioning signals from satellites of another satellite positioning system to determine the position of the vehicle 10.

The wireless communication terminal 4 communicates with a wireless base station by wireless in conformity with a predetermined standard of mobile communications. The wireless communication terminal 4 receives map information representing the first or second map or update information of the first or second map from a map server via the wireless base station. The wireless communication terminal 4 outputs the received map information or update information to the storage device 5 via the in-vehicle network.

The storage device 5, which is an example of the storage unit, includes, for example, a hard disk drive, a nonvolatile semiconductor memory, or an optical medium and an access device therefor. The storage device 5 stores the first and second maps, and stores, for each of the first and second maps, update information indicating the dates and times of the last update of information on individual road sections represented in the map.

The storage device 5 further includes a processor for executing, for example, a process to update the first or second map and a process related to a request from the ECU 6 to read out a map. For example, every time the vehicle 10 moves a predetermined distance, the storage device 5 transmits a request to obtain first and second maps, together with the current position of the vehicle 10, to the map server via the wireless communication terminal 4. The storage device 5 then receives map information including the first and second maps of a predetermined region around the current position of the vehicle 10 from the map server via the wireless communication terminal 4, and stores the first and second maps included in the received map information. When update information of the first or second map is received via the wireless communication terminal 4, the storage device 5 stores the update information. When a request from the ECU 6 to read out a map is received, the storage device 5 cuts out that portion of the first and second maps stored therein which includes the current position of the vehicle 10 and which represents a region smaller than the predetermined region, and outputs the cutout portion to the ECU 6 via the in-vehicle network.

The ECU 6 executes autonomous driving control of the vehicle 10. In the present embodiment, the ECU 6 generates a planned trajectory, based on the first or second map, and executes autonomous driving control of the vehicle 10 to make the vehicle 10 travel along the generated planned trajectory.

As illustrated in FIG. 2, the ECU 6 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 6 to the in-vehicle network. Every time an image is received from the camera 2, the communication interface 21 passes the received image to the processor 23. Every time positioning information is received from the GPS receiver 3, the communication interface 21 passes the positioning information to the processor 23. In addition, the communication interface 21 passes the first and second maps and update information read from the storage device 5 to the processor 23.

The memory 22, which is another example of the storage unit, includes, for example, volatile and nonvolatile semiconductor memories, and stores various types of data used in a vehicle control process executed by the processor 23. For example, the memory 22 stores images of the surroundings of the vehicle 10 received from the camera 2, positioning information of the vehicle 10 received from the GPS receiver 3, and the first and second maps and update information read from the storage device 5. The memory 22 further stores parameters of the camera 2 such as the focal length, the orientation, and the mounted position as well as various parameters for specifying a classifier for object detection, which is used for detecting, for example, a feature. Further, the memory 22 temporarily stores various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10 at predetermined intervals.

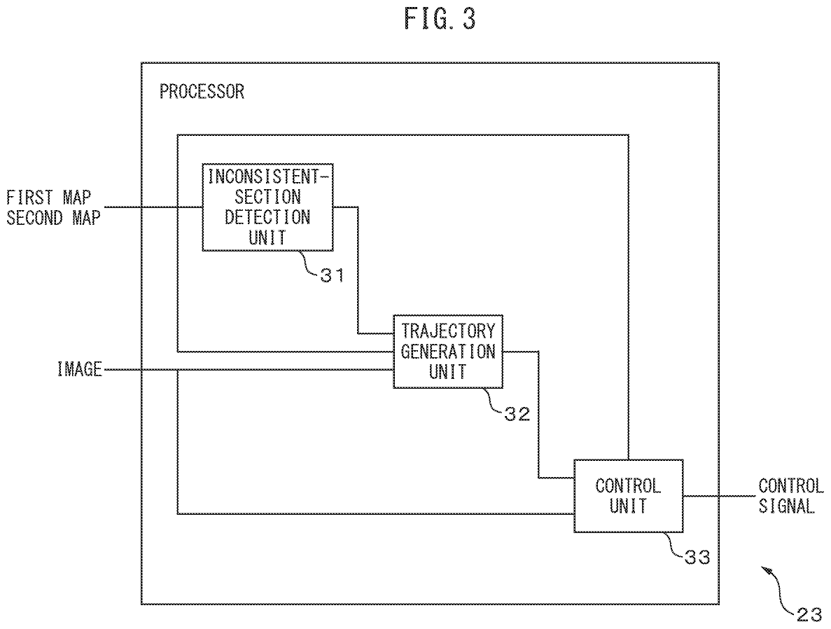

FIG. 3 is a functional block diagram of the processor 23, related to the vehicle control process. The processor 23 includes an inconsistent-section detection unit 31, a trajectory generation unit 32, and a control unit 33. These units included in the processor 23 are functional modules, for example, implemented by a computer program executed by the processor 23, or may be dedicated operating circuits provided in the processor 23.

The inconsistent-section detection unit 31 detects an inconsistent section where information on a road being traveled by the vehicle 10 represented in the first map is inconsistent with the information represented in the second map, in a section from the current position of the vehicle 10 to a predetermined distance away in the travel direction of the vehicle 10.

To achieve this, the inconsistent-section detection unit 31 determines the position of the vehicle 10 indicated by the latest positioning information as the current position of the vehicle 10. The inconsistent-section detection unit 31 identifies the travel direction of the vehicle 10, based on the changes in the position of the vehicle 10 indicated by the latest pieces of positioning information or on a sensor signal indicating the orientation of the vehicle 10 received by the ECU 6 from an orientation sensor (not illustrated) mounted on the vehicle 10. In addition, the inconsistent-section detection unit 31 identifies the road including the current position of the vehicle 10 as the road being traveled by the vehicle 10, by referring to the first or second map being used for generating a planned trajectory at present.

The inconsistent-section detection unit 31 sets sampling points at first intervals (e.g., intervals of several hundred meters to 1 km) in a section from the current position of the vehicle 10 to a predetermined distance away along the travel direction of the vehicle 10. For each sampling point, the inconsistent-section detection unit 31 calculates the distance between the position of a feature on or around the road being traveled by the vehicle 10 (e.g., a lane-dividing line, a curbstone, a guardrail, or a signpost) represented in the first map at the sampling point and the position of a corresponding feature represented in the second map, as the degree of inconsistency. When a feature extending along the road, such as a lane-dividing line in the above example, is used for calculating the degree of inconsistency, the inconsistent-section detection unit 31 calculates the distance to that position of a corresponding feature represented in the second map which is closest to the position of the feature represented in the first map at a sampling point of interest, as the degree of inconsistency. The inconsistent-section detection unit 31 may calculate an average of the distances between the positions of features represented in the first map at a sampling point of interest and those of corresponding features represented in the second map, as the degree of inconsistency.

The inconsistent-section detection unit 31 compares the degrees of inconsistency calculated for the respective sampling points with a predetermined threshold, and identifies a sampling point where the degree of inconsistency is not less than the predetermined threshold. In front of and behind the sampling point where the degree of inconsistency is not less than the predetermined threshold, the inconsistent-section detection unit 31 resets sampling points at second intervals (e.g., intervals of several dozen meters to 100 m) each of which is shorter than the first interval. For each reset sampling point, the inconsistent-section detection unit 31 calculates the degree of inconsistency between the first and second maps in the same manner as described above. Among the reset individual sampling points, the inconsistent-section detection unit 31 identifies sampling points where the degree of inconsistency is not less than the predetermined threshold. The inconsistent-section detection unit 31 then detects a section from the sampling point previous to the one closest to the vehicle 10 of the sampling points where the degree of inconsistency is not less than the predetermined threshold to the sampling point next to the one farthest from the vehicle 10 of the sampling points where the degree of inconsistency is not less than the predetermined threshold, as an inconsistent section. The inconsistent-section detection unit 31 may detect multiple inconsistent sections by repeating the above-described processing.

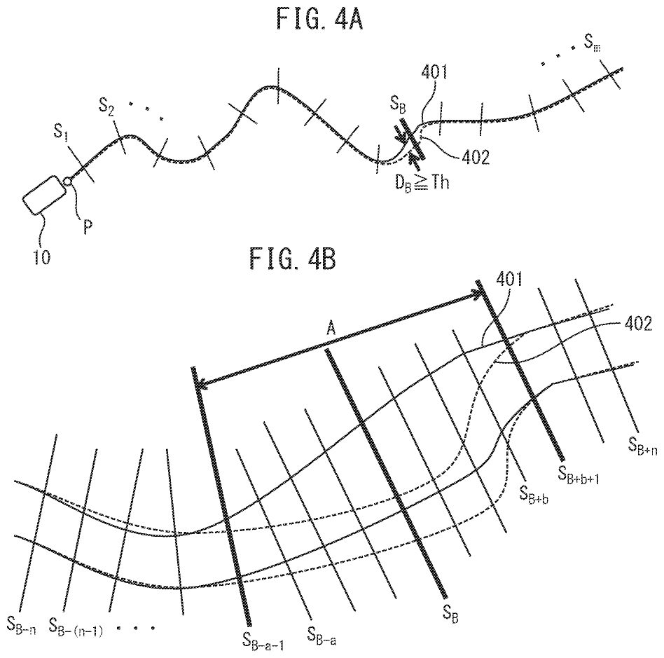

FIGS. 4A and 4B schematically illustrate an example of the relationship between the degree of inconsistency of two maps and an inconsistent section. In FIG. 4A, the vehicle 10 is exaggerated. As illustrated in FIG. 4A, sampling points Sᵢ (i=1, 2, . . . , m) are set on a road being traveled by the vehicle 10 from the current position P of the vehicle 10 at first intervals. For each sampling point Sᵢ, the degree of inconsistency Dᵢ between a lane-dividing line 401 represented in the first map and a corresponding lane-dividing line 402 represented in the second map is calculated. In this example, the degree of inconsistency D_{B} is not less than a predetermined threshold Th at a sampling point S_{B}.

Hence, as illustrated in FIG. 4B, sampling points Sⱼ (j=B−n, B−(n−1), . . . , B−1, B, B+1, . . . , B+n) are reset in front of and behind the sampling point S_{B} at second intervals. For each sampling point Sⱼ, the degree of inconsistency Dⱼ between the lane-dividing line 401 represented in the first map and the corresponding lane-dividing line 402 represented in the second map is calculated. In this example, the degree of inconsistency Dⱼ is not less than the predetermined threshold Th in a section from a sampling point S_{B-a} to a sampling point S_{B+b}. Hence, a section from the sampling point S_{B-a-1} previous to the sampling point S_{B-a} to the sampling point S_{B+b+}1 next to the sampling point S_{B+b} is identified as an inconsistent section A.

The inconsistent-section detection unit 31 may assign the degree of inconsistency not less than the predetermined threshold to a sampling point where the number of lanes or the number of lane-dividing lines differs between the first and second maps. The inconsistent-section detection unit 31 may also assign the degree of inconsistency not less than the predetermined threshold to a sampling point where the type of lane-dividing line differs between the first and second maps. In addition, the inconsistent-section detection unit 31 may set a point where the presence or absence of a predetermined feature, such as a signpost or a guardrail, differs between the first and second maps, as a sampling point having the degree of inconsistency not less than the predetermined threshold.

According to a modified example, the inconsistent-section detection unit 31 may calculate the degree of inconsistency as in the embodiment for each of points spaced at predetermined intervals (e.g., intervals of several dozen meters to 100 m) along the travel direction of the vehicle 10 in ascending order of distance from the current position of the vehicle 10. Then the inconsistent-section detection unit 31 determines a point where the degree of inconsistency first exceeds a first threshold (e.g., the same threshold as the predetermined threshold) as the start point of an inconsistent section. Among the points farther from the vehicle 10 than the start point of the inconsistent section, the inconsistent-section detection unit 31 determines a point where the degree of inconsistency first falls below a second threshold, as the end point of the inconsistent section. The second threshold for identifying the end point of an inconsistent section may be set less than the first threshold for identifying the start point of an inconsistent section. This prevents setting of inconsistent sections alternating with other sections in a short distance or erroneous detection of the end point of an inconsistent section. In some embodiments, the thresholds are set to values greater than the average, median, or mode of the errors in the positions of individual features represented in the second map. This prevents a point where information on a road represented in the first map is substantially the same as information on the road represented in the second map from being erroneously included in an inconsistent section.

When the distance between two successive inconsistent sections is less than a predetermined distance threshold (e.g., several hundred meters to 1 km), the inconsistent-section detection unit 31 may set a continuous section including these two inconsistent sections as a new single inconsistent section. Similarly, when the distances between two successive inconsistent sections among three or more inconsistent sections are less than the distance threshold, the inconsistent-section detection unit 31 may set a continuous section including these three or more inconsistent sections as a new single inconsistent section. This prevents frequent switches of maps used for generating a planned trajectory and thus prevents generation of an unnatural planned trajectory, which prevents unnatural motion of the vehicle 10 and thus prevents making the driver unnecessarily anxious.

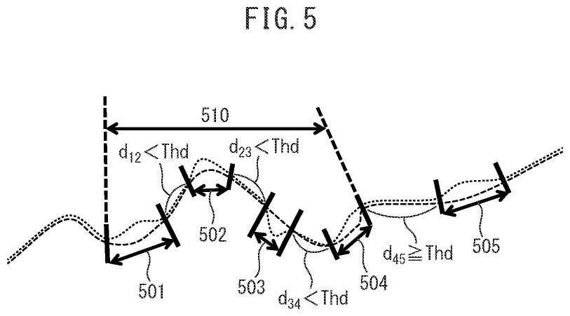

FIG. 5 schematically illustrates an example of detection of an inconsistent section according to this modified example. In the example illustrated in FIG. 5, five inconsistent sections 501 to 505 are detected on the basis of the degrees of inconsistency at individual points on a road being traveled by the vehicle 10. However, the distance d₁₂ between the inconsistent sections 501 and 502 is less than a predetermined distance threshold Thd. Similarly, the distance d₂₃ between the inconsistent sections 502 and 503 and the distance d₃₄ between the inconsistent sections 503 and 504 are also less than the predetermined distance threshold Thd. In contrast, the distance d₄₅ between the inconsistent sections 504 and 505 is not less than the predetermined distance threshold Thd. Hence, a section 510 from the start point of the inconsistent section 501 to the end point of the inconsistent section 504 is newly detected as an inconsistent section. However, the inconsistent section 505 remains separate from the inconsistent section 510.

The inconsistent-section detection unit 31 notifies the trajectory generation unit 32 of the start point and the end point of the detected inconsistent section.

The trajectory generation unit 32 generates a planned trajectory from the current position of the vehicle 10 to a predetermined distance away, based on the first or second map. In the present embodiment, the trajectory generation unit 32 generates a planned trajectory regarding the inconsistent section, based on a map, of the first and second maps, with a shorter elapsed time since the timing of the last update. Regarding a section except the inconsistent section, the trajectory generation unit 32 generates a planned trajectory, based on the first map.

First, the trajectory generation unit 32 detects a lane being traveled by the vehicle 10 (hereafter a “host vehicle lane”). Specifically, the trajectory generation unit 32 detects the host vehicle lane by comparing an image representing the surroundings of the vehicle 10 and generated by the camera 2 (hereafter simply an “image”) with the first or second map used for generating a planned trajectory at the current position of the vehicle 10. For example, assuming the position and orientation of the vehicle 10, the trajectory generation unit 32 projects features on or around the road detected from an image onto the map or features on or around the road in the vicinity of the vehicle 10 represented in the map onto the image. The features on or around the road may be, for example, road markings such as lane-dividing lines or stop lines, or curbstones. The trajectory generation unit 32 then estimates the actual position of the vehicle 10 to be the position and orientation of the vehicle 10 for the case where the features detected from the image match those represented in the map the best, and detects a lane including the position of the vehicle on the map as the host vehicle lane.

The trajectory generation unit 32 uses initial values of the assumed position and orientation of the vehicle 10 and parameters of the camera 2, such as the focal length, the height of the mounted position, and the orientation, to determine the positions in the map or the image to which the features are projected. As the initial values of the position and orientation of the vehicle 10 is used the latest position of the vehicle 10 measured by the GPS receiver 3 or the position obtained by correcting, with odometry information, the position and orientation of the vehicle 10 estimated at the last detection of the host vehicle lane. The trajectory generation unit 32 then calculates the degree of matching between the features on or around the road detected from the image and the corresponding features represented in the map (e.g., the inverse of the sum of squares of the distances between corresponding features).

The trajectory generation unit 32 repeats the above-described processing while varying the assumed position and orientation of the vehicle 10, and estimates the actual position of the vehicle 10 to be the assumed position and orientation for the case where the degree of matching is a maximum. The trajectory generation unit 32 then refers to the map to identify the lane including the position of the vehicle 10 as the host vehicle lane.

For example, the trajectory generation unit 32 inputs an image into a classifier that has been trained to detect detection target features from an image, thereby detecting these features. As such a classifier, the trajectory generation unit 32 can use a deep neural network (DNN) having architecture of a convolutional neural network (CNN) type, such as Single Shot MultiBox Detector or Faster R-CNN. Alternatively, as such a classifier, the trajectory generation unit 32 may use a DNN having architecture of a self-attention network (SAN) type, e.g., Vision Transformer.

Upon detection of the host vehicle lane, the trajectory generation unit 32 generates a line passing through the center between the left and right lane-dividing lines demarcating the host vehicle lane represented in the map as a planned trajectory.

When the map used for generating the planned trajectory is switched between the inconsistent section and the sections in front and behind, i.e., when the second map is used for generating a planned trajectory in the inconsistent section, the trajectory generation unit 32 further connects the planned trajectory generated regarding the inconsistent section and the planned trajectories generated regarding the sections in front and behind with predetermined curves. To this end, the trajectory generation unit 32 generates a planned trajectory in a section of several dozen meters around the boundary between the inconsistent section and the section in front with the predetermined curve. Similarly, the trajectory generation unit 32 generates a planned trajectory in a section of several dozen meters around the boundary between the inconsistent section and the section behind with the predetermined curve. As the predetermined curve, the trajectory generation unit 32 can use a curve expressed by a sigmoid function or a spline function. Alternatively, the trajectory generation unit 32 may use a clothoid curve as the predetermined curve.

The trajectory generation unit 32 notifies the control unit 33 of the generated planned trajectory.

The control unit 33 controls components of the vehicle 10 to make the vehicle 10 travel along the planned trajectory received from the trajectory generation unit 32. To achieve this, the control unit 33 measures the position of the vehicle 10 at predetermined intervals, and compares the measured position of the vehicle 10 with the planned trajectory. The control unit 33 measures the correct position of the vehicle 10 by comparing an image obtained by the camera 2 with the map used for generating the planned trajectory, in a manner similar to that described in relation to the trajectory generation unit 32. When the measured position of the vehicle 10 is on the planned trajectory, the control unit 33 determines the steering angle of the vehicle 10 so that the vehicle 10 proceeds along the planned trajectory, and controls the steering of the vehicle 10 so that the steering angle is the same as determined. When the measured position of the vehicle 10 is apart from the planned trajectory, the control unit 33 determines the steering angle of the vehicle 10 so that the vehicle 10 approaches the planned trajectory, and controls the steering of the vehicle 10 so that the steering angle is the same as determined.

Further, the control unit 33 sets the acceleration or deceleration of the vehicle 10 so as to keep the distance between the vehicle 10 and another vehicle traveling ahead not less than a certain distance. To achieve this, the control unit 33 detects a vehicle ahead by inputting an image obtained by the camera 2 or a ranging signal obtained by a range sensor (not illustrated) into a classifier that has been trained to detect a vehicle. The control unit 33 then estimates the distance between the vehicle 10 and the vehicle ahead, based on the size of the vehicle ahead in the image or the bottom position of the region representing the vehicle ahead or based on that distance in the direction to the detected vehicle ahead which is indicated by the ranging signal. When the distance between the vehicle 10 and the vehicle ahead falls below a predetermined distance threshold, the control unit 33 sets the acceleration or deceleration of the vehicle 10 to decelerate the vehicle 10. When the distance between the vehicle 10 and the vehicle ahead is not less than the predetermined distance threshold, the control unit 33 sets the acceleration or deceleration of the vehicle 10 to keep the speed of the vehicle 10 constant or to approach the regulation speed of a road being traveled by the vehicle 10 or a target speed set by the driver. Then the control unit 33 sets the degree of accelerator opening or the amount of braking according to the set acceleration or deceleration. The control unit 33 determines the amount of fuel injection according to the set degree of accelerator opening, and outputs a control signal depending on the amount of fuel injection to a fuel injector of an engine of the vehicle 10. Alternatively, the control unit 33 determines electric power to be supplied to a motor according to the set degree of accelerator opening, and controls a driving circuit of the motor so that the determined electric power is supplied to the motor. Alternatively, the control unit 33 outputs a control signal depending on the set amount of braking to the brake of the vehicle 10.

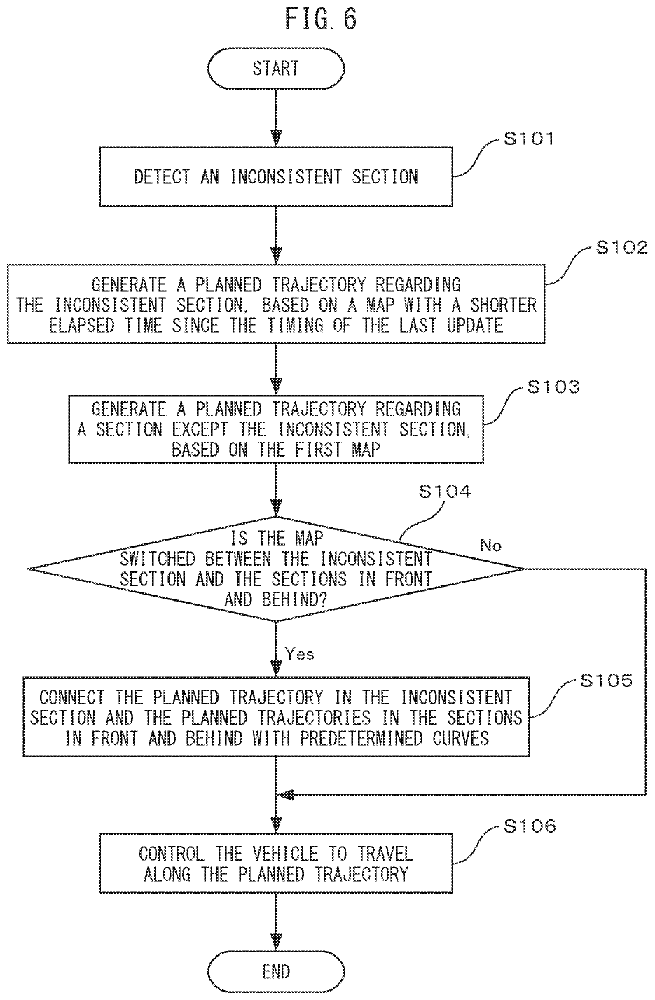

FIG. 6 is an operation flowchart of the vehicle control process executed by the processor 23. Every time the vehicle 10 travels a predetermined distance or a predetermined time elapses, the processor 23 executes the vehicle control process in accordance with the operation flowchart described below.

The inconsistent-section detection unit 31 of the processor 23 detects an inconsistent section where information on a road being traveled by the vehicle 10 represented in the first map is inconsistent with the information represented in the second map, in a section from the current position of the vehicle 10 to a predetermined distance away in the travel direction of the vehicle 10 (step S101). Regarding the inconsistent section, the trajectory generation unit 32 of the processor 23 generates a planned trajectory, based on a map, of the first and second maps, with a shorter elapsed time since the timing of the last update (step S102). Regarding a section except the inconsistent section, the trajectory generation unit 32 generates a planned trajectory, based on the first map (step S103). In addition, the trajectory generation unit 32 determines whether the map used for generating the planned trajectory is switched between the inconsistent section and the sections in front and behind (step S104). When the map used for generating the planned trajectory is switched (Yes in step S104), the trajectory generation unit 32 connects the planned trajectory generated regarding the inconsistent section and the planned trajectories generated regarding the sections in front and behind with predetermined curves (step S105).

When the map used for generating the planned trajectory is not switched (No in step S104) or after step S105, the control unit 33 of the processor 23 controls the vehicle 10 so that the vehicle 10 travels along the generated planned trajectory (step S106). The processor 23 then terminates the vehicle control process.

As has been described above, the vehicle controller generates a planned trajectory, using one of two pieces of map information updated at different timings, and makes a vehicle travel along the generated planned trajectory. Regarding the inconsistent section, in particular, the vehicle controller generates a planned trajectory, based on a map, of the two maps, with a shorter elapsed time since the timing of the last update of information on the road in the inconsistent section. This enables the vehicle controller to generate a planned trajectory, based on a map that is more likely to represent actual information on the road. Thus the vehicle controller can prevent erroneously generating a planned trajectory such that the vehicle deviates from a lane being traveled.

According to a modified example, the trajectory generation unit 32 may generate the planned trajectory from a position that is a predetermined offset distance closer to the vehicle than the inconsistent section, based on a map, of the first and second maps, with a shorter elapsed time since the timing of the last update of information on the road in the inconsistent section. This enables the trajectory generation unit 32 to generate an appropriate planned trajectory such that deviation from a host vehicle lane will not occur in the inconsistent section, even if a certain time is necessary for switching maps used for generating the planned trajectory.

According to another modified example, a map server may execute processing similar to the processing of the inconsistent-section detection unit 31, thereby detecting an inconsistent section. In this case, when delivering first and second maps to the vehicle 10, the map server also delivers inconsistent-section information for identifying an inconsistent section included in a region represented in the first and second maps. In this case, the storage device 5 also stores the inconsistent-section information received via the wireless communication terminal 4. By referring to the inconsistent-section information, the inconsistent-section detection unit 31 identifies the inconsistent section within a predetermined distance of the current position of the vehicle 10 along the travel direction of the vehicle 10. According to this modified example, the computational burden of the processor 23 of the ECU 6 is reduced.

The computer program for achieving the functions of the processor 23 of the ECU 6 according to the embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present disclosure.

What is claimed is:

1. A vehicle controller comprising:
a memory configured to store a first map and a second map each representing information on a road, the first and second maps being updated at different timings; and
a processor configured to:
detect, in a travel direction of a vehicle, an inconsistent section where information on a road represented in the first map is inconsistent with information on the road represented in the second map, the road being traveled by the vehicle,
generate a planned trajectory to be traveled by the vehicle regarding a section from a current position of the vehicle to a predetermined distance away in the travel direction of the vehicle except the inconsistent section, based on the first map,
generate the planned trajectory regarding the inconsistent section, based on a map, of the first and second maps, with a shorter elapsed time since the timing of the last update of information on the road in the inconsistent section, and
control the vehicle so that the vehicle travels along the planned trajectory.

2. The vehicle controller according to claim 1, wherein the information on the road represented in the first map is more accurate than the information on the road represented in the second map, and the second map is updated more frequently than the first map.

3. The vehicle controller according to claim 1, wherein the processor is further configured to connect the planned trajectory generated regarding the inconsistent section and the planned trajectories generated regarding sections in front of and behind the inconsistent section with predetermined curves.

4. The vehicle controller according to claim 1, wherein the processor generates the planned trajectory from a point that is a predetermined offset distance closer to the current position of the vehicle than a start point of the inconsistent section closest to the current position of the vehicle in the inconsistent section, based on the map, of the first and second maps, with a shorter elapsed time since the timing of the last update of information on the road in the inconsistent section.

5. The vehicle controller according to claim 1, wherein when two inconsistent sections separated by a distance less than a predetermined distance threshold are detected, the processor determines a continuous section including the two inconsistent sections as a single inconsistent section.

6. A method for vehicle control, comprising:
detecting, in a travel direction of a vehicle, an inconsistent section where information on a road represented in a first map is inconsistent with information on the road represented in a second map, the road being traveled by the vehicle, the first and second maps being updated at different timings;
generating a planned trajectory to be traveled by the vehicle regarding a section from a current position of the vehicle to a predetermined distance away in the travel direction of the vehicle except the inconsistent section, based on the first map;
generating the planned trajectory regarding the inconsistent section, based on a map, of the first and second maps, with a shorter elapsed time since the timing of the last update of information on the road in the inconsistent section; and
controlling the vehicle so that the vehicle travels along the planned trajectory.

7. A non-transitory recording medium that stores a computer program for vehicle control, the computer program causing a processor mounted on a vehicle to execute a process comprising:
detecting, in a travel direction of the vehicle, an inconsistent section where information on a road represented in a first map is inconsistent with information on the road represented in a second map, the road being traveled by the vehicle, the first and second maps being updated at different timings;
generating a planned trajectory to be traveled by the vehicle regarding a section from a current position of the vehicle to a predetermined distance away in the travel direction of the vehicle except the inconsistent section, based on the first map;
generating the planned trajectory regarding the inconsistent section, based on a map, of the first and second maps, with a shorter elapsed time since the timing of the last update of information on the road in the inconsistent section; and
controlling the vehicle so that the vehicle travels along the planned trajectory.
